(19) United States
(12) Patent Application Publication
(10) Pub. No.: US 2023/0214588 A1
(43) Pub. Date: Jul. 6, 2023

(54) AUTOMATIZED PARSING TEMPLATE CUSTOMIZER

(71) Applicant: coretech lt, UAB, Vilnius (LT)

(72) Inventors: Andrius KUKSTA, Vilnius (LT); Martynas JURAVICIUS, Vilnius (LT)

(73) Assignee: coretech lt, UAB, Vilnius (LT)

(21) Appl. No.: 17/570,181

(22) Filed: Jan. 6, 2022

(51) Int. Cl. G06F 40/221; G06F 16/958; G06F 40/186; G06F 40/14

(52) U.S. Cl. CPC G06F 40/221; G06F 16/986; G06F 40/186; G06F 40/14

(57) ABSTRACT

Systems and methods to intelligently adapt parsing rules according to the layout changes occurring in multiple targets are disclosed. Specifically, the disclosure provides a solution to detect the layout changes in a target domain and to update parsing templates or parsing rules. The disclosed embodiments in one aspect describe methods and systems to receive and store parsing templates or parsing rules and monitoring tables or a list of related URLs within an internal storage facility. Methods and systems to scrape and parse data by following parsing rules or using parsing templates. The methods and systems describe the manner in which the parsed data and the actual data are analyzed to detect any changes in the layout of the target domain(s). The methods and systems give details on how to decide whether to update parsing rules or parsing templates depending on the layout changes in the target domains.

### FIELD

The disclosure belongs to the field of data collection and parsing technology. Methods and systems disclosed herein are generally directed to enable web scrapers and data parsers to automatically adapt to the layout changes occurring in one or more target web domains.

### BACKGROUND

Web scraping, also known as web data extraction, is the process of gathering web data in an automated manner. More technically, web scraping refers to the process of gathering data from one or more web resources over the internet by any means other than a human employing a web browser or a program interacting with an application programming interface. Web scraping techniques have several use cases, including but not limited to price monitoring, price intelligence, news monitoring.

Web scrapers are computer programs written for web scraping that usually comprise two main sub-elements: a crawler and a scraper. A crawler or a web crawler (generally also referred to as “spider”) is an artificial intelligence that browses the Internet to index and searches for content by following several links. In general, a web scraping project first begins by crawling one or more websites or web targets to discover URLs which are then passed on to the scraper. A scraper or a web scraper is a specialised tool designed to extract data from a web page accurately and efficiently. Web scrapers can vary immensely in design and complexity depending on the implementation and specific project requirements. Most scrapers comprise a data locator (or selectors) that are used to discover or locate the necessary data to be extracted from the HTML file—usually, XPath, CSS selectors, regex, or a combination of the aforementioned terms.

To elaborate further, a web scraper is a tool and/or software program designed specifically to extract data from a specific website(s). Furthermore, a web scraper, for example, sends HTTP requests to a target website and extracts the data from it. In most cases, a web scraper sends the HTTP request to an application programming interface (APIs) to obtain relevant data like product prices or contact details. In computing, an API is a set of programming codes that enables data transmission between one computer program and another. API also defines the rules and regulations for the exchange of data between computer programs.

Currently, several kinds of web scrapers are available that can be utilized to suit the needs of different scraping projects. For example, one scraping project may need a web scraper that can identify HTML site structures, or extract, reformat and store data from APIs. In general, web scrapers are large frameworks designed for a plurality of scraping tasks/projects. However, in some instances, general-purpose libraries (such as but not limited to HTTP request library) are also used to create a web scraper.

Web scraping, at its basic level, comprises the following steps: a) identifying a target website; b) collecting URLs of the webpages where a scraping client wants to extract data from; c) Making requests to these URLs to receive the HTML of the webpages; d) using locators or parsers to identify the data within the HTML; e) saving the data in a, for example, JSON or CSV file or another format.

Needless to mention that there are several challenges associated with web scraping and web scrapers. For example, maintaining the scraper if the website layout changes, managing proxies and dealing with antibots are some of the few significant challenges in the field of web scraping. Especially, website layout changes are one of the substantial challenges to web scrapers and will be discussed later in this disclosure.

In computer networking, an HTTP request is made by a client to a host server in order to access/receive one or more resources. A client can request any form of resource such as multimedia files, text files, HTML pages, JSP files, archived data, etc. In order to send an HTTP request, the client uses the components of a URL (Uniform Resource Locator), which contains the necessary information to access the resources on the host server properly. Briefly, a URL is defined as any character string that identifies a resource on a network. A URL is used when a web client makes a request to a server for a resource.

To send an HTTP request, the client uses components of a URL that includes the information needed to access the resource. A rightly composed HTTP request comprises the following elements:
a. a request line;
b. a series of HTTP headers or header fields;
c. a message-body if needed.

The request line is the first line in an HTTP request message and consists of at least three items:
a. A ‘method’. The ‘method’ is a single-word command that informs the server of what must be done with a particular resource. For example, the server could be asked to send a specific resource to the client.
b. The path component of the URL for the request. The path identifies the resource on the server.
c. The HTTP version number, showing the HTTP specification to which the client has tried to make the message comply.

The request line may also include a few additional items such as a query string and the scheme and the host components of the URL. A query string provides a string of information that informs the server about the purpose of certain resources. The query string is written after the path and is preceded by a question mark.

HTTP headers are written on a message to provide the recipient server with information about the message, the client, and how the client wants to communicate with the server. Each HTTP header is made up of a name and a value. The HTTP protocol specifications define the standard set of HTTP headers and describe the proper ways to use these headers. HTTP messages can also include extensions headers, which are not part of the HTTP/1.1 or HTTP/1.0 specifications. In brief, the HTTP headers for a client's request contain information that a server can use to decide how to respond to the request.

The message of an HTTP request can also be referred to as an entity-body. Technically, the entity-body is the actual content of the message. The entity-body can be in its original state or encode in a specific way for transmission, such as being broken into chunks (chunked transfer-encoding). Message bodies are appropriate for some request methods and inappropriate for others. For example, a request with the POST method, which sends input data to the server, has a message body containing the data. A request with the GET method, which asks the server to send a resource, does not have a message body.

In the field of computer sciences, HTML (HyperText Markup Language) is the code that is used to structure a webpage and its content. For example, content could be structured within a set of paragraphs, a list of bulleted points or using images and data tables. To elaborate, HTML is a markup language that defines the structure of a webpage. HTML consists of a series of elements, which are used by the website administrators to enclose or wrap different parts of the content to render it in a certain layout or act a certain way when clicked.

The basic components of an HTML document are a) tags, b) attributes, c) elements. An HTML tag is written between angled brackets and acts as a container for different types of content. Each tag has its own specific meaning, and the same applies to the content within it. Attributes are used in an HTML document to provide additional information about a particular element. An attribute is applied within the start tag of a particular element and contains two fields: name and value. Lastly, an element in an HTML document can be regarded as the building block of an HTML document. In simple terms, elements are everything written within tags, including the tags, contents, and attributes.

Likewise, XML stands for Extensible Markup Language. This programming language facilitates the encoding of documents defined by a set of rules in a format that both humans and machines read. By using tags, XML defines the document structure, how it should be stored and transported. XML also enables the creation of web pages and is a dynamic language that provides the means to exchange data efficiently.

In computer programming, XPath (stands for XML Path language) is used to uniquely identify or address parts of an HTML and/or XML document. An XPath expression can be used to search through an HTML document and extract information from any part of the document, such as an element or attribute (referred to as a node) in it. Simply put, XPath is a query language for selecting nodes (elements or attributes) from an HTML/XML document. In addition, XPath may be used to compute values (e.g., strings, numbers, or boolean values) from the content of an HTML/XML document. It must be understood that XPath was defined and instituted by the World Wide Web Consortium. The XPath language is based on a tree representation of the HTML document and provides the ability to navigate around the tree, selecting nodes by a variety of criteria, in general use, an XPath expression is often referred to simply as “an XPath”.

Diverging back to the subject of web scraping, it would be beneficial to elucidate the term data parsing. In simple terms, web scraping provides a solution for clients seeking access to a vast amount of structured web data in an automated method. Data parsing, simply put, is a process when one data format is transformed into another (i.e., more readable data format). However, technically parsing refers to the process of converting one or more strings of data into a different type of data. For example, raw HTML can be converted into a more readable data format using parsing techniques. In short, Data parsing is a widely used method for data structuring. In the case of web scraping, parsing occurs after data has been scraped or extracted from a web page.

A parser (i.e., computer programs writer for parsing data) can distinguish which information of the HTML string must be extracted. Following a pre-written code or rules, a parser can extract the necessary information and convert the extracted information into formats, for example, formats such as JSON, CSV or even a simple table. It is important to understand that a parser itself is not related to a specific data format. However, a parser is a tool that converts one data format into another depending on a pre-written code or rules configured into the parser.

One must understand that parsing is very vital to the field of web scraping as it involves structuring the scraped data to make them readable or understandable to the clients. In general, developers often govern the process of parsing by a written code or rules, which informs the parser about specific data that requires to be extracted and structured. In addition, the rules can direct the parser to locate the specific data in a raw HTML file.

Advanced web scrapers are also capable of parsing the required data. In other words, most modern scrapers may include a parser feature configured within them. Furthermore, advanced web scrapers can collect, process, aggregate and present large databases consisting of numerous pages at once. In simple terms, web scrapers aid in automating the onerous process of collecting and processing large amounts of data.

Web scrapers, in most instances, employ proxies in order to access a target website. Using a proxy (especially a pool of proxies) allows a web scraper to crawl a website much more reliably and significantly reduces the chances of being blocked by the website. Furthermore, proxies enable a web scraper to request from a specific geographical region or device (for example, mobile IPs), which enables the web scrapers to retrieve region-specific content from the website. In short, scraping product data from a global e-commerce website is made more accessible through the usage of proxies. One must understand that the term proxy refers to a third-party intermediary server that routes the requests originated from web scrapers using its IP addresses (i.e., proxy's IP address) in the process. Therefore, the target website can only know the IP address of the proxy server but not the IP address of the web scraper. Thus, proxies are associated with the ability to provide online anonymity.

In recent times, several advancements have been made in the field of web scraping to satisfy the varying requirements of scraping clients. However, there are a few persistent challenges to web scraping that need to be overcome. Most websites are based on HTML; hence, web designers can often change layouts of several web pages available within these websites. In most instances, layout changes are done to include new data or to improve overall customer experiences.

However, layout changes in the web pages of a target website can be a critical challenge for data parsers. As described previously, parsers are often governed by pre-defined rules that direct them to locate specific data in a raw HTML file. Specifically, parsers follow the pre-defined rules to locate and extract specific data from a raw HTML file and structure them according to the clients' requirements later. Therefore, layout changes to the web pages of a target website can render the pre-defined rules invalid. The pre-defined rules of a parser must be updated and/or adjusted according to the new layout changes so that the parser can locate the specific data correctly. However, changing the pre-defined rules of a parser according to layout changes of a target website can be resource-intensive and time-consuming. Moreover, suppose the parser deals with the web pages of different websites; in such cases, the task of changing or adjusting the pre-defined rules can be an onerous undertaking.

The embodiments of the present disclosure provide systems and methods to alleviate the challenges of adjusting the pre-defined rules mentioned previously, according to the layout changes occurring in the web pages of one or more target websites. In addition, the embodiments disclosed herein enable parsers to adapt to the layout changes in an automated manner, thereby reducing the required human effort, resources and time. In brief, the embodiments disclosed herein enable both web scrapers and data parsers to scrape and parse the relevant data by adapting accurately to the layout changes of one or more target websites. More specifically, the embodiments disclosed herein provide at least the following solutions: a) systems and methods to parse raw HTML efficiently by following a predefined set of rules; b) systems and methods to analyze the parsed data to calculate the percentage of accuracy; c) systems and methods to intelligently decide whether to update the pre-defined rules followed by the parser; d) systems and methods to update the pre-defined rules followed by the parser according to the layout changes in the web pages of one or more target websites and e) systems and methods to store the updated pre-defined rules internally at a service provider infrastructure.

### SUMMARY

The summary provided herein presents a general understanding of the exemplary embodiments disclosed in the detailed description accompanied by drawings. Moreover, this summary is not intended, however, as an extensive or exhaustive overview. Instead, the only purpose of this summary is to present the condensed concepts related to the exemplary embodiments in a simplified form as a prelude to the detailed description.

The disclosed embodiments provide solutions to intelligently adapt and update parsing templates depending on the layout changes in target web domains. The current disclosure describes solutions to scrape and parse data by adhering to parsing templates. Further, the current disclosure details the manner in which the parsed data are analyzed and compared with the actual data to decide whether parsing templates need updating. Specifically, the disclosure calculates the accuracy percentages by analyzing and comparing the actual and parsed data. Furthermore, the embodiments of the current disclosure describe solutions to automatically update the existing parsing templates according to the layout changes in target domains.

### BRIEF DESCRIPTION OF THE DRAWINGS

FIG. 1 shows a block diagram of an exemplary architectural depiction of various elements of the embodiments disclosed herein.

FIG. 2 is an exemplary depiction of a parsing template.

FIG. 3 is an exemplary sequence diagram showing how a single instance of parsing template and its associated monitoring table are stored in storage unit 108.

FIG. 4A is an exemplary sequence diagram showing the steps involved in updating the parsing template stored in storage unit 108.

FIG. 4B is the continuation of an exemplary sequence diagram showing the steps involved in updating the parsing template stored in storage unit 108.

FIG. 4C is the continuation of an exemplary sequence diagram showing the steps involved in updating the parsing template stored in storage unit 108.

FIG. 4D is the continuation of an exemplary sequence diagram showing the steps involved in updating the parsing template stored in storage unit 108.

FIG. 5 shows a block diagram of an exemplary computing system.

### DETAILED DESCRIPTION

The following detailed description is provided below along with accompanying figures to illustrate the main aspects of the embodiments disclosed herein. While one or more aspects of the embodiments are described, it should be understood that the described aspects are not limited to any one embodiment. On the contrary, the scope of the present embodiments are only limited by the claims and furthermore, the disclosed embodiments may encompass numerous alternatives, modifications and equivalents. For the purpose of example, several details are described in the following description in order to give a comprehensive understanding of the present embodiments. A person of ordinary skills in the art will understand that the described embodiments may be implemented or practised according to the claims without some or all of these specific details. In addition, standard or well-known methods, procedures, components and/or systems have not been described in detail so as not to obscure the crucial parts of the disclosed exemplary embodiments.

Some general terminology descriptions may be helpful and are included herein for convenience and are intended to be interpreted in the broadest possible interpretation. Elements that are not imperatively defined in the description should have the meaning as would be understood by a person skilled in the art.

Service provider infrastructure 102 (SPI 102) can be a combination of elements comprising the platform that provides data collection and parsing services according to one or more clients' requirements. In the current embodiments, SPI 102 comprises scraping engine 104, parsing engine 106, the storage unit 108, data analyzer 110, template updater 112 and infrastructure gateway 114.

Scraping engine 104, as mentioned above, is an element of SPI 102 and primarily responsible for data collection operations (i.e, scraping) on one or more web targets (represented by target domain 118). To elaborate, scraping engine 104 can access a plurality of web targets or web domains (represented by target domain 118) and perform scraping operations against such targets via network 116. In the same context, scraping engine 104 can receive response data, for example, the raw HTML documents from a plurality of web targets or web domains (represented by target domain 118). Scraping engine 104 is communicably connected with parsing engine 106 and storage unit 108. Specifically, scraping engine 104 can access, select and fetch one or more parsing templates from the storage unit 108. Likewise, the scraping engine can access, select and fetch one or more monitoring tables from the storage unit 108. In addition, scraping engine 104 can send one or more parsing templates and raw HTML documents to parsing engine 106.

Parsing engine 106 is an element of SPI 102 and can be any framework implementation of a data parsing system. Parsing engine 106, for the most part, is responsible for executing parsing operations on scraped data, for example, on raw HTML documents received from the scraping engine 104. Especially, parsing engine 106 can parse data from multiple scraped data by using the instructions or rules available within the parsing templates. In addition, parsing engine 106 can add the parsed values to monitoring tables stored in storage unit 108. Thus, parsing engine 106 can access and make modifications to the data (i.e., monitoring tables) stored in the storage unit 108. The parsing engine 106 is communicably connected with storage unit 108 and scraping engine 104.

Storage unit 108 can comprise computer components and other elements that are capable of storing and retaining a wide range of data. Further, storage unit 108 can be any storage device, medium or facility responsible for storing data such as but not limited to multiple parsing templates combined with their associated monitoring tables and scraped data (for example, raw HTML documents). Storage unit 108 is communicably connected with scraping engine 104, parsing unit 106, data analyzer 110, template updater 112 and infrastructure gateway 114. Storage unit 108 can store, arrange and organize data into rows and columns to make processing and data querying efficient.

Data analyzer 110, as mentioned previously, is an element of SPI 102 and can comprise one or more sub-components capable of performing computing and logical operations. The data analyzer 110 is primarily responsible for analyzing vast amounts of data, Especially, data analyzer 110 calculates one or more metrics necessary for deciding intelligently whether parsing templates need updating. In addition, the metric(s) aid data analyzer 110 in ascertaining the accuracy levels of parsing templates and the actual parsing operations. In simple terms, the metrics signify how accurate the parsing operations have been executed by the parsing engine 106. The metrics are calculated by comparing and analyzing the actual and parsed data. Since the metrics provide the accuracy levels of parsing templates and the actual parsing operations, SPI 102 can configure a minimum acceptable accuracy level within data analyzer 110. Data analyzer 110 can decide whether to update the parsing templates based on the minimum acceptable accuracy level. For example, the minimum acceptable accuracy level may be configured as 50% by SPI 102.

The minimum acceptable accuracy level is set to maintain a certain accuracy level of the parsing operations and, SPI 102 can set the value for the minimum acceptable accuracy level. Data analyzer 110 decides the need to update the parsing template by comparing the calculated metric against the minimum acceptable accuracy level.

Template updater 112 is primarily responsible for receiving the decision(s) to update the parsing templates from data analyzer 110 and finding new instructions or rules necessary for updating the parsing templates, In the current embodiments, instructions or rules in a parsing template are used by parsing engine 106 to locate and extract data belonging to specific data fields from the raw HTML documents. WebKit or other similar browsing engine may be used to determine data located at a particular XPath or CSS within a raw HTML document. Further, the instructions or rules present in the parsing templates can be any of the following, but are not limited to:
a. XPath expressions
b. CSS selector strings
c. a combination of Xpath and programming algorithms

Furthermore, template updater 112 can access storage unit 108 and update the parsing templates with the newly found instructions or rules. Template updater 112 may comprise one or more computing elements necessary to process vast amounts of raw HTML documents. In the present embodiments, template updater 112 is an element of the service provider infrastructure 102.

Infrastructure gateway 114 (IG 114) is an element of the SPI 102 and may comprise interface(s) by which the IG 114 can receive data from elements external to SPI 102. Infrastructure gateway 114 can send the received data to storage unit 108 where the received data are stored. In some embodiments, the data can be manually uploaded to the infrastructure gateway 114. The data that is received by IG 114 are but are not limited to parsing templates and their associated monitoring tables.

Network 116 is a digital telecommunications network that allows nodes to share and access resources. Examples of a network: local-area networks (LANs), wide-area networks (WANs), campus-area networks (CANs), metropolitan-area networks (MANs), home-area networks (HANs), Intranet, Extranet, Internetwork, Internet.

Target domain 118 is an exemplary instance of a web domain providing media contents, resources, information or services over the network 116. Target domain 118 can be identified and accessed by, for example, a particular IP address, URL, domain name, and/or hostname, possibly with a defined network protocol port that represents a resource address or a remote system serving the content accessible through industry-standard protocols. Target domain 118 may be situated on a physical server or on a cloud server.

In one exemplary instance of the current embodiments, data analyzer 110 calculates the ‘accuracy percentage’ or ‘percentage of accuracy’, an exemplary metric necessary to decide whether parsing template(s) need updating and, in general, ascertain the accuracy levels of parsing templates and the parsing operations. The term accuracy percentage, as used herein, refers to a numerical metric calculated by the data analyzer 110 by comparing and analyzing the actual and parsed data.

In the current embodiments, the term actual data refers to the actual value that corresponds to a specific data field from the web pages of the target domain 118. The actual data can be obtained manually from a website or raw HTML documents. For example, if “price” is a data field, then the actual price of the product or the service will be considered as the actual data that corresponds to the data field “price”.

In the current embodiments, parsed data refers to the data obtained through parsing the raw HTML documents by using the parsing templates. Specifically, in the current disclosure, parsed data is obtained by parsing the raw HTML documents by using the instructions or rules defined in the parsing template. The parsing engine 106 is responsible for parsing and obtaining the parsed data from the raw HTML documents.

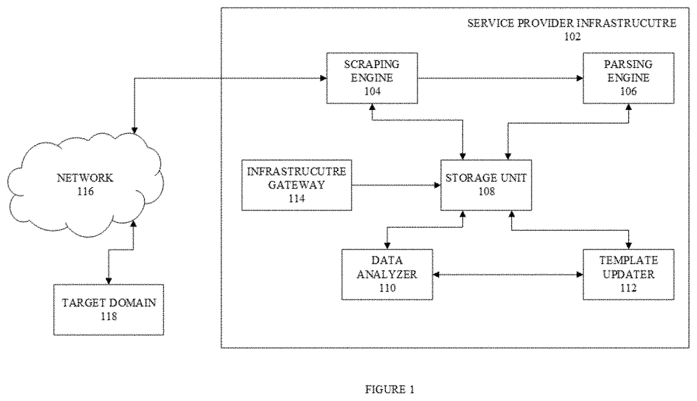

FIG. 1 shows a block diagram of an exemplary architectural depiction of various elements of the embodiments disclosed herein. FIG. 1 shows a single instance of service provider infrastructure 102, target domain 118 and network 116. 1n the exemplary block diagram of FIG. 1, the service provider infrastructure 102 comprises scraping engine 104, parsing engine 106, storage unit 108, data analyzer 110, template updater 112 and infrastructure gateway 114 (IG 114). However, one of the ordinary skills in the art will appreciate that SPI 102 can comprise other elements or a combination of elements (not shown or described) necessary to support the execution of data collection and parsing operations—for example, but not unlimited to proxy rotators, proxy servers and support APIs.

Within SPI 102, it is important to note that scraping engine 104 and parsing engine 106 are communicably connected with each other. Moreover, scraping engine 104 and parsing engine 106 are connected individually with storage unit 108, as depicted in FIG. 1. In the same context, data analyzer 110 and template updater 112 are communicably connected with each other. Further, the aforementioned elements (i.e., the data analyzer 110 and template updater 112) are connected individually with storage unit 108. The infrastructure gateway 114 is communicably connected with storage unit 108. It must be recalled that IG 114 may comprise interface(s) by which data and/or files and/or documents can be received from elements external to SPI 102 (not shown).

A person of ordinary skills in the art will understand that the elements shown in FIG. 1 implement exemplary embodiments. In some embodiments, certain elements may be referred to by different titles or may be combined into a single element instead of two separate elements (for example, scraping engine 104 and parsing engine 106 can be co-located into a single element). However, such arrangements or consolidations do not alter the elements' functionality or the flow of information between the elements of SPI 102. Therefore, FIG. 1, shown, should be interpreted as exemplary only and not restrictive or exclusionary of other features, including features discussed in other areas of this disclosure.

Network 116 in FIG. 1, as described previously can be any local area network (LANs), wide-area networks (WANs), campus-area networks (CANs), metropolitan-area networks (MANs), home-area networks (HANs), Intranet, Extranet, Internetwork, Internet. However, the Internet is the most relevant network for the functioning of the present embodiment. Connection to network 116 may require that scraping engine 104 and target domain 118 execute software routines that support the implementation of, for example, TCP/IP communications. In FIG. 1, scraping engine 104 is shown as having access to network 116; however, in some embodiments, SPI 102 may configure other elements (such as for example, infrastructure gateway 114) to access network 116.

In FIG. 1, infrastructure gateway 114 may receive a plurality of parsing templates and their associated monitoring tables from one or more elements external to SPI 102. In some embodiments, the aforesaid data (i.e., a plurality of parsing templates and their associated monitoring tables) can be manually uploaded to the infrastructure gateway 114. Afterwhich, IG 114 forwards the parsing templates and their associated monitoring tables to the storage unit 108. Consequently, a plurality of parsing templates and their associated monitoring tables are stored within the storage unit 108. It must be recalled that storage unit 108 can be any storage device, medium or facility responsible for storing a wide range of data.

In the present embodiments, parsing templates provide instructions or rules for the parsing engine 106 to perform the parsing operations efficiently. Specifically, parsing templates comprise, among other things, instructions or rules necessary for parsing engine 106 to locate and extract data belonging to specific data fields from raw HTML documents.

Parsing templates, in some instances (for example, at the initial stage) may be prepared manually prior to uploading or sending them to infrastructure gateway 114. In one exemplary instance, a parsing template may be prepared manually by analyzing HTML documents and finding the instructions or rules to locate data belonging to specific data fields. As mentioned earlier, the instructions or rules can be any of the following, but not limited to: a) XPaths; b) CSS selector strings; c) a combination of XPaths and programming algorithms. The data fields are chosen based on the requirements of one or more scraping clients. Thus, a parsing template can comprise but is not limited to data field(s) and their corresponding instructions or rules.

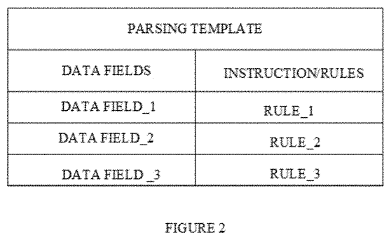

An exemplary depiction of a parsing template is shown in FIG. 2. The exemplary parsing template shown in FIG. 2 comprises data fields and their corresponding instructions or rules. For the sake of clarity, the exemplary parsing template is shown comprising three data fields. However, in actuality, parsing templates can comprise multiple data fields and their corresponding instructions or rules. One must understand that parsing engine 106 uses the instructions or rules in the parsing templates to parse (i.e., to locate and extract) the data belonging to the corresponding data fields from the scraped data, for example, raw HTML documents.

In the present embodiments, a parsing template is always associated with a monitoring table. In some instances (for example, at the initial stage), monitoring tables may be prepared along with their associated parsing templates prior to uploading or sending them to infrastructure gateway 114. In one exemplary instance, a monitoring table associated with a particular parsing template may comprise multiple URLs of a target web domain. The URLs are generally of the same category, for example, URLs of product pages of a target e-commerce web domain. In addition, each URL is accompanied by actual data of the data fields specified in its associated parsing template. For example, the actual data for the data field “title” is the actual title of a product. Similarly, a product's price will be the actual data for the data field “price”. Therefore, a monitoring table may comprise multiple URLs and the actual data corresponding to the specific data fields.

Returning to FIG. 1, in one aspect, the scraping engine 104 can fetch parsing template(s) and their associated monitoring table(s) from the storage unit 108. Scraping engine 104 may either query the aforesaid data (i.e., parsing template(s) and their associated monitoring table(s)) from the storage unit 108 or may directly access and fetch the data mentioned above. After fetching parsing template(s) and their associated monitoring table(s), scraping engine 104 uses the URLs (present in the monitoring table) to access and scrape the web pages of a specific target web domain (represented by target domain 118). Consequently, scraping engine 104 can receive data (for example, raw HTM1. documents) from the URLs (i.e., the webpages) of the target web domain as a result of the aforementioned scraping operations.

Following the scraping operations, scraping engine 104 can send the parsing template(s) and the raw HEW documents (i.e., scraped data) to parsing engine 106. The parsing engine 106 receives the data (i.e., the parsing template(s) and the scraped data) and can parse (i.e., can locate and extract) specific data from the raw HTML documents (i.e, scraped data) using the instructions or rules specified in the parsing template(s). The data parsed by the parsing engine 106 corresponds to the data fields specified in the parsing template(s). Therefore, after completing the parsing operations, parsing engine 106 can access storage unit 108 to add the parsed data to the monitoring table(s) associated with the parsing template(s). In addition, the parsing engine 106 sends the raw HTML documents (i.e, the scraped data) to storage unit 108, where the raw HTML documents are stored.

Subsequently, data analyzer 110 can fetch the actual and parsed data present in the monitoring table(s) from storage unit 108. A person of ordinary skills in the art will understand that data analyzer 110 can either directly access and fetch the actual data and parsed data from the storage unit 108 or query the aforesaid data from storage unit 108. After which, data analyzer 110 analyzes the fetched data (i.e., the actual and parsed data) and calculates the metric necessary for intelligently deciding whether parsing templates need updating. In one exemplary instance of the current embodiments, the data analyzer 110 calculates an exemplary metric referred to as the ‘percentage accuracy’ by comparing the actual and parsed data.

To elaborate further, when the calculated metric is below the minimum acceptable accuracy level, data analyzer 110 decides to update the parsing template(s). However, when the calculated metric is equal to or higher minimum acceptable accuracy level, data analyzer 110 decides not to update the parsing template(s). One must recall that the minimum acceptable accuracy level is configured initially by the SPI 102. For example, the minimum acceptable accuracy level may configured as 50% by the SPE 102.

In the current embodiments, if the calculated metric is below the minimum acceptable accuracy level, it implies that the instructions or rules present in the parsing template(s) must be updated or changed. Furthermore, the need to update or change the instructions or rules present in the parsing template(s) implies that the layout of the web pages has changed in the target domain. As a result, parsing engine 106 could no longer parse the correct data from the raw HTML documents (i.e, the scraped data) using the existing instructions or rules in the parsing template(s). Therefore, in order to parse the correct data from raw HTML documents (i.e., the scraped data), the data analyzer 110 decides to update the parsing template(s) whenever the calculated metric falls below the minimum acceptable accuracy level. However, if the calculated metric is equal to or higher than the minimum acceptable accuracy level, the process of scraping, parsing and calculating the metric is repeated at regular intervals.

When data analyzer 110 decides to update the parsing template(s), it (i.e., the data analyzer 110) informs the template updater 112 about the decision to update the parsing template(s). After receiving the decision to update the parsing template(s), template updater 112 can fetch the actual data present in the monitoring table(s) and the raw HTML documents from the storage unit 108. Consequently, template updater 112 can find and prepare new instructions or rules necessary for updating the parsing template(s). Specifically, template updater 112 finds and prepares new instructions or rules to locate the actual data in the raw HTML, documents (i.e, the scraped data). One must remember that the actual data corresponds to the specific data fields mentioned in the parsing template(s).

In one exemplary instance of the current embodiments, template updater 112 finds XPaths for the actual data from the raw HTML document (i.e, the scraped data). Further, in the same exemplary instance, template updater 112 analyzes the XPaths to identify the frequently occurring XPaths, which are considered as the new XPaths necessary to update the parsing template(s).

After finding and preparing new instructions or rules, template updater 112 can access storage unit 108 and update the parsing template(s) with the new instructions or rules. To elaborate further, template updater 112 replaces the existing instructions or rules with the new instructions or rules for the corresponding data fields. In one exemplary instance of the current embodiments, template updater 112 replaces the existing XPaths with the newly found XPaths for the corresponding data fields.

Therefore, when the process of scraping, parsing and calculating the metric repeats at the next consecutive cycle, the scraping engine 104 can fetch the updated parsing template from the storage unit 108.

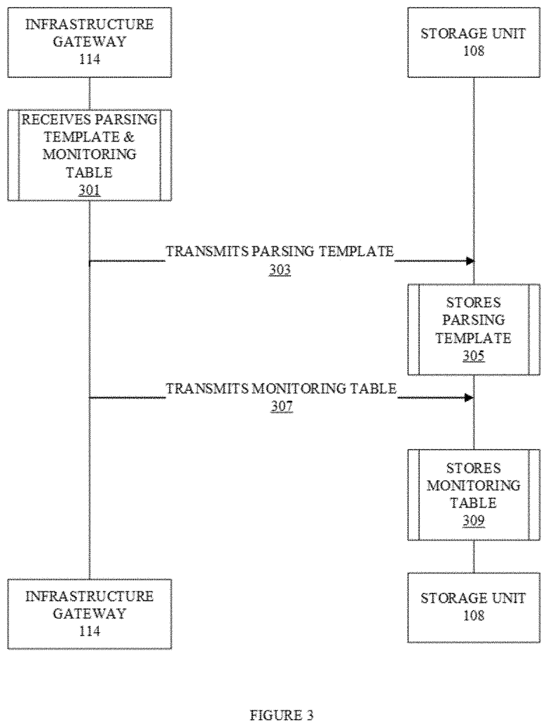

FIG. 3 is an exemplary sequence diagram showing how a single instance of parsing template and its associated monitoring table are stored in storage unit 108. Furthermore, the parsing template shown in the exemplary sequence diagram comprises XPaths as instructions or rules for parsing (i.e., locating and extracting) the data belonging to the specific data fields mentioned in the parsing template.

In step 301, IG 114 receives a parsing template and its associated monitoring table from an element or elements external to the service provider infrastructure 102. Specifically, IG 114 can comprise interface(s) by which the parsing template and its associated monitoring table are received from an element or elements external to SPI 102. In step 303, IG 114 transmits the received parsing template to storage unit 108 for the purpose of storage. Accordingly, in step 305, storage unit 108 stores the parsing template within its storage facilities. In step 307, IG 114 transmits the monitoring table associated with the parsing template to storage unit 108 for the purpose of storage. Accordingly, in step 309, storage unit 108 stores the monitoring table associated with the parsing template within its storage facilities. It must be recalled that storage unit 108 can be any storage device, medium or facility responsible for storing a wide range of data.

One must understand that FIG. 3 is only an exemplary embodiment, in actuality, IG 114 can send the parsing template and monitoring table to storage unit 108 in a single step instead of two consecutive steps as described above. Moreover, from the above-provided description, one can understand the manner in which the parsing templates and their associated monitoring tables are stored in storage unit 108.

As mentioned earlier, in the present embodiments, parsing templates provide instructions or rules for the parsing engine 106 to perform the parsing operations efficiently. Specifically, parsing templates comprise, among other things, instructions or rules necessary for parsing engine 106 to locate and extract data belonging to specific data fields from the scraped data, for example, raw HTML documents.

Parsing templates, in some instances (for example, at the initial stage) may be prepared manually prior to uploading or sending them to infrastructure gateway 114. In one exemplary instance, a parsing template may be prepared manually by analyzing HTML documents and finding the instructions or rules to locate data belonging to specific data fields. As mentioned earlier, the parsing template shown in the current exemplary sequence diagram (i.e., FIG. 3) comprises XPaths as instructions or rules for parsing (i.e., locating and extracting) the data belonging to the specific data fields mentioned in the parsing template. However, the instructions or rules can be any of the following, but not limited to: a) XPaths; b) CSS selector strings; c) a combination of XPaths and programming algorithms. Moreover, the data fields in the parsing template are chosen based on the requirements of one or more scraping clients. Thus, a parsing template can comprise but is not limited to data field(s) and their corresponding instructions or rules.

A parsing template always has an associated monitoring table. As elaborated previously, in some instances (for example, at the initial stage), monitoring tables may be prepared along with the parsing template prior to uploading or sending them to infrastructure gateway 114. In one exemplary instance, a monitoring table associated with a particular parsing template may comprise multiple URLs of a target web domain. The URLs are generally of the same category, for example, URLs of product pages of a target e-commerce web domain. In addition, each URL is accompanied by actual data of the data fields specified in the parsing template. For example, the actual data for the data field “title” is the actual title of a product. Similarly, the price of a product will be the actual data for the data field “price”.

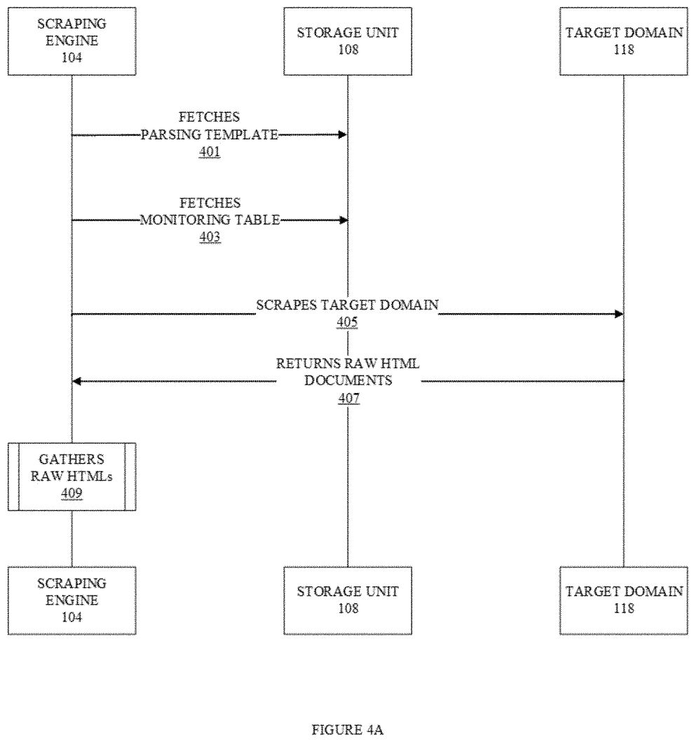

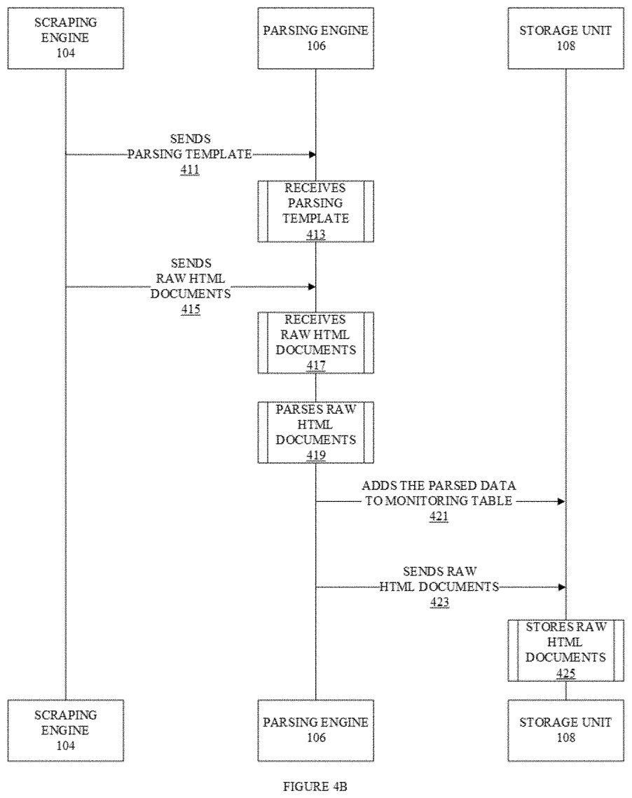

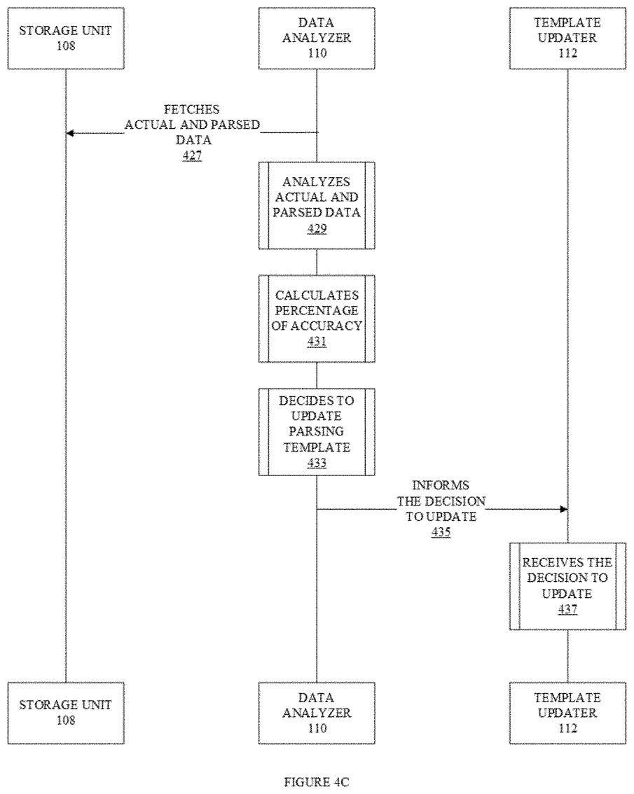

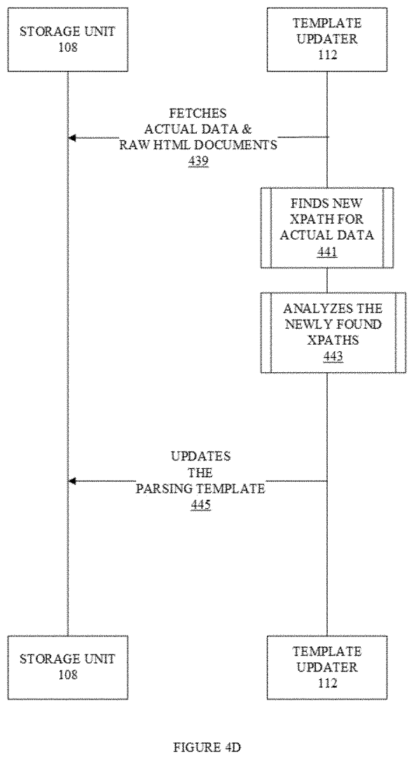

FIGS. 4A-4D are exemplary sequence diagrams showing the steps involved in updating the parsing template stored in storage unit 108. It must be understood that in the current exemplary sequence diagrams (FIGS. 4A-4D) the parsing template comprises) (Paths as instructions or rules for parsing (i.e., locating and extracting) the data belonging to the specific data fields mentioned in the parsing template. However, the instructions or rules can be any of the following, but not limited to: a) XPaths; b) CSS selector strings; a combination of XPaths and programming algorithms. Moreover, the scraped data is raw HTML documents in the current exemplary diagrams (FIGS. 4A-4D).

The sequence diagram begins at FIG. 4A. In step 401, scraping engine 104 accesses and fetches the parsing template from the storage unit 108. Consecutively, in step 403, scraping engine 104 accesses and fetches the monitoring table associated with the parsing template from the storage unit 108. One must understand that at this particular instance (i.e., the commencement of the process flow described in FIG. 4), the parsing template and its associated monitoring table are stored already within the storage unit 108, as described previously in relation to FIG. 3.

in step 405, scraping engine 104 uses the URLs present in the monitoring table to scrape each web page of target domain 118. Therefore step 405 is shown as scraping engine 104 accessing the target domain in order to access and scrape the URLs (i.e., webpages) of target domain 118. In response to the scraping operations, target domain 118 returns raw HTML documents to scraping engine 104 (step 407). In step 409, scraping engine 104 receives and gathers every raw HTML document from target domain 118 (specifically, from the URLs of target domain 118).

FIG. 4B continues the sequence diagram from FIG. 4A. In step 411, the scraping engine sends the parsing template to parsing engine 106. Subsequently, the parsing engine in step 413 receives the parsing template from scraping engine 104. In step 415, scraping engine 104 sends the raw HTML documents associated with the parsing template to parsing engine 106. Subsequently, the parsing engine 106 in step 417 receives the monitoring table associated with the parsing template from scraping engine 104.

In step 419, the parsing engine parses the raw HTML documents based on (or in other words by using) the XPaths (i.e., the instruction or rules) specified in the parsing template. Especially, the parsing engine 106 uses the XPaths specified in the parsing template to locate and extract the data from the raw HTML documents. One must understand that the parsed data belongs to the specific data fields specified in the parsing template. After completing the parsing operations, in step 421, the parsing engine 106 accesses the storage unit 108 and adds the parsed data to the monitoring table. In step 423, the parsing engine 106 sends the raw HTML documents to storage unit 108 for storage. Accordingly, in step 425, the storage unit stores the raw HTML documents within its storage facilities.

FIG. 4C continues the sequence diagram from FIG. 4B. In step 427 the data analyzer 110 fetches the actual and parsed data from the storage unit 108. One must recall that the monitoring table stored in storage unit 108 comprises among other things, the actual data and parsed data. The parsed data was added to the monitoring table by parsing engine 106 as described above. In step 429, the data analyzer 110 compares and anlyzes the actual and parsed data in order to calculate the metric necessary for deciding intelligently whether parsing templates need updating. In the current exemplary sequence diagrams (FIGS. 4A 4D) the data analyzer 110 is shown as calculating an exemplary metric referred to as the accuracy percentage. Accordingly, in step 431, data analyzer 110 calculates the percentage of accuracy. The accuracy percentage is calculated to know how accurate the parsing operations are performed by the parsing engine 106. Furthermore, the accuracy percentage shows how relevant and accurate the parsing template(s) are for the parsing operations.

In step 433, after calculating the accuracy percentage, data analyzer 110 decides to update the parsing template based on the minimum acceptable accuracy level configured by SPI 102. As previously described, SPI 104 among other things, can configure data analyzer 110 with the minimum acceptable accuracy level based on which data analyzer 110 can decide whether to update the parsing template. To elaborate further, suppose the accuracy percentage is below the minimum acceptable accuracy level, in such cases, the data analyzer 110 decides to update the parsing template and informs the decision to template updater 112, However, suppose the accuracy percentage is equal to or higher than the minimum acceptable accuracy level, in such cases, the data analyzer 110 does not decide to update the parsing template.

In the current exemplary sequence diagrams (FIG. 4A-4D), SPI 102 configures the minimum acceptable accuracy level as 50%. However a person of ordinary skills in the art will understand that the value for the minimum acceptable accuracy level can be changed depending upon the preferences of SPI 102. Moreover, FIG. 4A-AD is an exemplary sequence diagram showing the instance when the accuracy percentage is below the minimum accuracy level i.e., 50%. Therefore, in step 433, the data analyzer decides to update the parsing template.

In the current exemplary sequence diagrams (FIG. 4A-4D), if the accuracy percentage is below the minimum acceptable accuracy level, it implies that the XPaths present in the parsing template(s) must be updated or changed. Furthermore, if there is a need to update or change the XPaths present in the parsing template(s), then such instances imply that the layout of the web pages has changed in the target domain. As a result, the parsing engine 106 could no longer parse accurate data from the raw HTML documents in consecutive instances. Therefore, in order to accurately parse data from the raw HTML documents, the data analyzer 110 decides to update the parsing template(s) whenever the accuracy percentage falls below the minimum acceptable accuracy level.

In step 435, the data analyzer 110 informs about the decision to update the parsing template to template updater 112 by sending, for example, a system message or a signal. Consequently, in step 437, template update 112 receives the decision to update the parsing template.

FIG. 4D continues the sequence diagram from FIG. 4C. In step 439, template updater 112 accesses and fetches the actual data and the raw HTML documents from the storage unit 108. One must recall that the monitoring table stored in storage unit 108 comprises, among other things, the actual data. Furthermore, storage unit 108 has previously stored the raw HTML documents received from the parsing engine 106.

In step 441, template updater 112 finds the new XPaths for the actual data from the raw HTML documents. Specifically, the template updater 112 uses the actual data in order to find its XPaths from the raw HTML documents. In step 443, template updater 112 analyzes the newly found XPaths to identify and select the most occurring XPaths. One must note that the template updater 112 finds the new Xpaths from multiple HTML documents for each of the actual data. As previously mentioned, the term actual data refers to the actual value that corresponds to a specific data field. Also, one must understand that when template updater 112 finds the new Xpaths, there may be multiple Xpaths corresponding to a specific data field. In such instances, template updater 112 analyzes and identifies (in step 443) the most occurring Xpath corresponding to each data field. So the at step 443 the most frequently occurring Xpath is selected. In step 445, template updater 112 accesses storage unit 108 and updates the parsing template with the new XPaths that are most occurring for each data field. Specifically, the template updater removes the previously present XPaths in the parsing template and updates it with the new XPaths that are most occurring for each data field.

Thus from the description provided above, one can appreciate the manner in which parsing templates are updated according to the layout changes in a target web domain. Moreover, the process described in FIG. 4A-4D is performed and repeated at regular intervals in order to check and update the parsing template stored in the storage unit 108.

Moreover as specified previously, FIG. 4A-4D is an exemplary sequence diagram showing the instance when the accuracy percentage is below the minimum acceptable accuracy level. However, if the accuracy percentage is equal to or higher than the minimum acceptable accuracy level then steps 401-431 are repeated at regular intervals after data analyzer 110 decides not to update the parsing template.

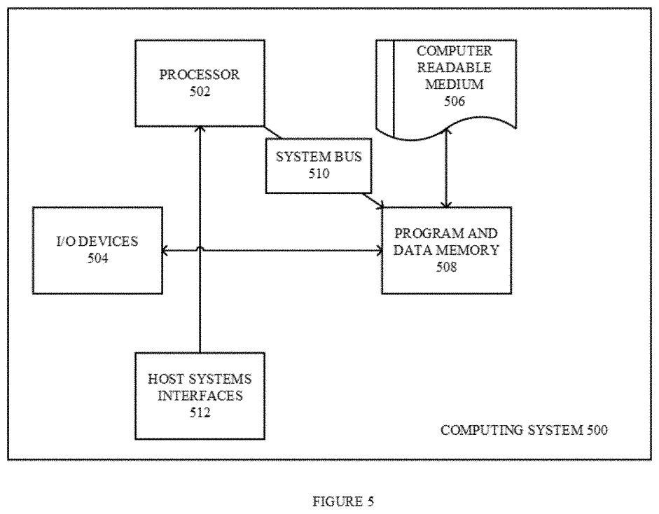

The embodiments herein may be combined or collocated in a variety of alternative ways due to design choice. Accordingly, the features and aspects herein are not in any way intended to be limited to any particular embodiment. Furthermore, one must be aware that the embodiments can take the form of hardware, firmware, software, and/or combinations thereof. In one embodiment, such software includes but is not limited to firmware, resident software, microcode, etc. FIG. 5 illustrates a computing system 800 in which a computer-readable medium 503 may provide instruction for performing any methods and processes disclosed herein.

Furthermore, some aspects of the embodiments herein can take the form of a computer program product accessible from the computer-readable medium 506 to provide program code for use by or in connection with a computer or any instruction execution system. For the purposes of this description, the computer-readable medium 506 can be any apparatus that can tangibly store the program code for use by or in connection with the instruction execution system, apparatus, or device, including the computing system 500.

The computer-readable medium 506 can be any tangible electronic, magnetic, optical, electromagnetic, infrared, or semiconductor system (or apparatus or device). Some examples of a computer-readable medium 506 include solid-state memories, magnetic tapes, removable computer diskettes, random access memories (RAM), read-only memories (ROM), magnetic disks, and optical disks. Some examples of optical disks include read-only compact disks (CD-ROM), read/write compact disks (CD-R/W), and digital versatile disks (DVD).

The computing system 500 can include one or more processors 502 coupled directly or indirectly to memory 508 through a system bus 510. The memory 508 can include local memory employed during actual execution of the program code, bulk storage, and/or cache memories, which provide temporary storage of at least some of the program code in order to reduce the number of times the code is retrieved from bulk storage during execution.

Input/output (I/O) devices 504 (including but not limited to keyboards, displays, pointing devices, I/O interfaces, etc.) can be coupled to the computing system 500 either directly or through intervening I/O controllers. Network adapters may also be coupled to the computing system 500 to enable the computing system 500 to couple to other data processing systems, such as through host systems interfaces 512, printers, and/or storage devices through intervening private or public networks. Modems, cable modems, and Ethernet cards are just examples of network adapter types.

Although several embodiments have been described, one of ordinary skill in the art will appreciate that various modifications and changes can be made without departing from the scope of the embodiments detailed herein. Accordingly, the specification and figures are to be regarded in an illustrative rather than a restrictive sense, and all such modifications are intended to be included within the scope of the present teachings. The benefits, advantages, solutions to problems, and any element(s) that may cause any benefit, advantage, or solution to occur or become more pronounced are not to be construed as a critical, required, or essential feature or element of any or all the claims. The invention is defined solely by the appended claims including any amendments made during the pendency of this application and all equivalents of those claims as issued.

Moreover, in this document, relational terms such as first and second, and the like may be used solely to distinguish one entity or action from another entity or action without necessarily requiring or implying any actual such relationship or order between such entities or actions. The terms “comprises”, “comprising”, “has”, “having”, “includes”, “including”, “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without additional constraints, preclude the existence of additional identical elements in the process, method, article, and/or apparatus that comprises, has, includes, and/or contains the element. The terms “a” and “an” are defined as one or more unless explicitly stated otherwise herein. The terms “approximately”, “about” or any other version thereof, are defined as being close to as understood by one of ordinary skill in the art. A device or structure that is “configured” in a certain way is configured in at least that way but may also be configured in ways that are not listed. For the indication of elements, singular or plural form can be used, but it does not limit the scope of the disclosure and the same teaching can apply to multiple objects, even if in the current application an object is referred to in its singular form.

The Disclosure is provided to allow the reader to quickly ascertain the nature of the technical disclosure. It is submitted with the understanding that it will not be used to interpret or limit the scope or meaning of the claims. In addition, in the foregoing Detailed Description, it is demonstrated that multiple features are grouped together in various embodiments for the purpose of streamlining the disclosure. This method of disclosure is not to be interpreted as reflecting an intention that the claimed embodiments require more features than are expressly recited in each claim. Rather, as the following claims reflect, the inventive subject matter lies in less than all features of a single disclosed embodiment.

The disclosure presents a method of assessing a web page parsing template comprising:

sending, by a scraping engine, a parsing template and scraped data to parsing engine, wherein the scraped data are associated with the parsing template;

receiving, by the parsing engine, a parsing template and the scraped data from the scraping engine;

parsing, by the parsing engine and using the parsing rules specified in the parsing template, the scraped data to create a parsed data;

adding, by the parsing engine, the parsed data to the monitoring table in a storage unit;

fetching, by the data analyzer, the actual and parsed data from the storage unit;

calculating, by the data analyzer, an accuracy percentage using the actual and parsed data; and

comparing, by the data analyzer, the accuracy percentage against an acceptable accuracy level to determine whether to update the parsing template.

The method is presented, further comprising, when the data analyzer decides to update the parsing template, informing the template updater.

The method is presented further comprising, when the accuracy percentage is below the acceptable accuracy level, updating, by the template updater, the parsing template.

The method is presented wherein the parsing template includes new parsing rules for the actual data.

The method is presented further comprising, when the accuracy percentage is equal to or higher than the acceptable accuracy level, keeping the parsing template unchanged.

The method is presented wherein the template updater accesses and fetches the actual data and the scraped data from the storage unit.

The method is presented wherein the parsed data corresponds to the data fields specified in the parsing template.

The method is presented wherein the scraped data are stored in the storage unit.

The method is presented wherein the parsing template and its monitoring table are stored within the storage unit.

The method is presented wherein the acceptable accuracy level is configured by the service provider infrastructure.

The method is presented wherein the parsing template comprises parsing rules of the data belonging to the specific data fields.

The method is presented wherein the parsing rules comprise any of the following or combination thereof: a) XPaths; b) CSS selector strings; c) a combination of XPaths and programming algorithms.

The method is presented wherein the scraped data is gathered by the scraping engine by accessing the URLs of a target web domain upon request from a client.

The method is presented wherein the monitoring table associated with a particular parsing template may comprise multiple URLs of a target web domain.

The method is presented wherein the URLs are accompanied by actual data of the data fields specified in the parsing template.

The method is presented wherein the accuracy percentage is a numerical metric for deciding whether the parsing template needs updating and to ascertain the accuracy levels of the parsing template.

The method is presented wherein the actual data refers to the actual value that corresponds to a specific data field from the URLs of the target web domain.

The disclosure presents a method of assessing a web page parsing template comprising:

sending by a scraping engine a parsing template and scraped data to parsing engine, wherein the scraped data are associated with the parsing template;

receiving by the parsing engine a parsing template and the scraped data from the scraping engine;

parsing, by the parsing engine, the scraped data using the parsing rules specified in the parsing template to create a parsed data;

adding by the parsing engine the parsed data to the monitoring table in a storage unit;

fetching by the data analyzer the actual and parsed data from the storage unit;

calculating by the data analyzer an accuracy percentage using the actual and parsed data;

deciding by the data analyzer to update the parsing template by comparing the accuracy percentage against the minimum acceptable accuracy level,

informing by the data analyzer the template updater to update the parsing template;

finding by the template updater new parsing rules for the actual data from the scraped data; and

updating by the template updater the parsing template.

The method is presented wherein the template updater accesses storage unit and updates the parsing template with the new parsing rules that are most occurring for each data field.

1. A method of assessing a web page parsing template comprising:
sending, by a scraping engine, a parsing template and scraped data to parsing engine, wherein the scraped data are associated with the parsing template;
receiving, by the parsing engine, a parsing template and the scraped data from the scraping engine;
parsing, by the parsing engine and using the parsing rules specified in the parsing template, the scraped data to create a parsed data;
adding, by the parsing engine, the parsed data to a monitoring table associated with the parsing template in a storage unit, wherein the monitoring table comprises one or more uniform resource locators (URLs) of a target web domain, and each URL of the one or more URLs is accompanied by actual data of data fields specified in the parsing template;
fetching, by the data analyzer, the actual data and the parsed data from the monitoring table in the storage unit;
calculating, by the data analyzer, an accuracy percentage for the parsing template using the actual data and the parsed data;
comparing, by the data analyzer, the accuracy percentage against an acceptable accuracy level to determine whether to update the parsing template; and
when the accuracy percentage is below the acceptable accuracy level, updating, by a template updater, the parsing template with new parsing rules for the actual data, the new parsing rules selected from a plurality of parsing rules based on a number of occurrences of respective parsing rules from the plurality of parsing rules.

2. The method of claim 1, further comprising, when the data analyzer decides to update the parsing template, informing the template updater.

3. The method of claim 2, further comprising, removing previously present parsing rules in the parsing template.

4. The method of claim 3, wherein the new parsing rules for the actual data comprises parsing rules that are most occurring for each data field.

5. The method of claim 2, further comprising, when the accuracy percentage is equal to or higher than the acceptable accuracy level, keeping the parsing template unchanged.

6. The method of claim 2, wherein the template updater accesses and fetches the actual data and the scraped data from the storage unit. (Original) The method of claim 1, wherein the parsed data corresponds to the data fields specified in the parsing template.

8. The method of claim 1, wherein the scraped data are stored in the storage unit.

9. The method of claim 1, wherein the parsing template and its monitoring table are stored within the storage unit.

10. The method of claim 1, wherein the acceptable accuracy level is configured by the service provider infrastructure.

11. The method of claim 1, wherein the parsing template comprises parsing rules of the data belonging to the specific data fields.

12. The method of claim 11, wherein the parsing rules comprise any of the following or combination thereof: a) XPaths; b) CSS selector strings; c) a combination of XPaths and programming algorithms.

13. The method of claim 1, wherein the scraped data is gathered by the scraping engine by accessing the URLs of a target web domain upon request from a client.

14. (canceled)

15. (canceled)

16. The method of claim 1, wherein the accuracy percentage is a numerical metric for deciding whether the parsing template needs updating and to ascertain the accuracy levels of the parsing template.

17. The method of claim 1, wherein the actual data refers to the actual value that corresponds to a specific data field from the URLs of the target web domain.

18. A method of assessing a web page parsing template comprising:
sending, by a scraping engine, a parsing template and scraped data to parsing engine, wherein the scraped data are associated with the parsing template;
receiving by the parsing engine, a parsing template and the scraped data from the scraping engine;
parsing, by the parsing engine, the scraped data using the parsing rules specified in the parsing template to create a parsed data;
adding by the parsing engine, the parsed data to a monitoring table associated with the parsing template in a storage unit, wherein the monitoring table comprises one or more uniform resource locators (URLs) of a target web domain, and each URL of the one or more URLs is accompanied by actual data of data fields specified in the parsing template;
fetching, by the data analyzer, the actual and parsed data from the monitoring table in the storage unit;
calculating, by the data analyzer, an accuracy percentage for the parsing template using the actual and parsed data;
deciding, by the data analyzer, to update the parsing template based on a comparison of the accuracy percentage against the minimum acceptable accuracy level;
informing, by the data analyzer, the template updater to update the parsing template;
finding, by the template updater, new parsing rules for the actual data from the scraped data, the new parsing rules selected from a plurality of parsing rules based on a number of occurrences of respective parsing rules from the plurality of parsing rules; and
updating by the template updater, the parsing template.

19. The method of claim 18, wherein the template updater accesses the storage unit and updates the parsing template with the new parsing rules that are most occurring for each data field.
